(19) United States
(12) Patent Application Publication
(10) Pub. No.: US 2026/0289763 A1
(43) Pub. Date: Sep. 24, 2026

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: Yasuhiro OKUNO, Tokyo (JP)

(21) Appl. No.: 19/457,264

(22) Filed: Jan. 23, 2026

(30) Foreign Application Priority Data
Mar. 19, 2025 (JP) 2025-045334

(51) Int. Cl. G06T 7/00; G06T 11/60; G06V 10/25

(52) U.S. Cl. CPC G06T 7/001; G06T 11/60; G06V 10/25; G06T 2207/20081; G06T 2207/20084

(57) ABSTRACT

An information processing apparatus includes at least one memory storing instructions; and at least one processor executing the stored instructions causing the information processing apparatus to: generate a high-quality image, based on an evaluation-target image using a neural network, the high-quality image having an image quality that is higher than an image quality of the evaluation-target image; and perform an evaluation of the image quality of the evaluation-target image based on a difference between the evaluation-target image and the high-quality image.

### BACKGROUND

### Field of the Technology

The present disclosure relates to an information processing apparatus that evaluates image quality of an image, an information processing method, and a storage medium.

### Description of the related Art

Image quality characteristics, such as blur or defocus are evaluated, and images are selected according to the evaluation results. Japanese Patent Application Laid-Open No. 2000-209476 discloses a method for selecting images with little defocus or camera shake by using the amount of high-frequency spatial components and the like as an evaluation value. Additionally, whether or not a sufficiently good image has been captured is determined based on whether or not the evaluation value exceeds a predetermined threshold, and the number of continuous shots is adjusted accordingly.

Evaluation values, such as the high-frequency spatial components or the contrast of an image, may vary depending on image capturing conditions (such as the size of the main subject in the image, the pattern of the subject itself, and illumination conditions). Even in cases in which focus is sufficiently achieved and camera shake or motion blur (subject blur) is absent, the evaluation value may become low.

In a case in which such an evaluation value is used, even if the evaluation value is relatively low, the image may be determined to be satisfactory for those particular image capturing conditions. Conversely, in very good image capturing conditions, an image may be determined to be unsatisfactory even though the evaluation value is relatively high. Thus, a drawback exists with conventional evaluation values based on spatial frequency components or contrast, in that it is difficult to define a reference value indicating how high the evaluation value should be to be considered sufficient for the given image capturing conditions.

Additionally, in a case in which such an evaluation value is used, although it is possible to determine the relative superiority or inferiority in image quality among pictures captured continuously under substantially the same image capturing conditions, it has been difficult to determine whether or not an image is sufficiently satisfactory under those conditions. Therefore, when images are selected based on such an evaluation value, a drawback arises in that unsatisfactory images may be selected, or satisfactory images may fail to be selected.

Additionally, it is also difficult to compare the superiority or inferiority between images captured under different image capturing conditions based on such an evaluation value.

### SUMMARY

The present disclosure is directed to provide a technology capable of performing image-quality evaluation according to the image capturing conditions.

According to an aspect of the present disclosure, an information processing apparatus includes at least one memory storing instructions; and at least one processor executing the stored instructions causing the information processing apparatus to: generate a high-quality image, based on an evaluation-target image using a neural network, the high-quality image having an image quality that is higher than an image quality of the evaluation-target image; and perform an evaluation of the image quality of the evaluation-target image based on a difference between the evaluation-target image and the high-quality image.

Features of the present disclosure will become apparent from the following description of embodiments with reference to the attached drawings. The following description of embodiments are described by way of example.

### BRIEF DESCRIPTION OF THE DRAWINGS

FIG. 1 is a block diagram illustrating an example of a configuration of an information processing apparatus according to a first embodiment.

FIG. 2 is a flowchart illustrating an example of overall processing performed by the information processing apparatus shown in FIG. 1.

FIG. 3 is a diagram for explaining an example of processing performed by a learning unit shown in FIG. 1.

FIG. 4 is a flowchart illustrating an example of processing performed by a difference display unit shown in FIG. 1.

FIG. 5 is a diagram for explaining an example of processing performed by the learning unit according to a second embodiment.

FIG. 6 is a block diagram illustrating an example of a configuration of the information processing apparatus according to a third embodiment.

FIG. 7 is a diagram for explaining an example of processing performed by the learning unit according to the third embodiment.

FIG. 8 is a flowchart illustrating an example of processing performed by an occluded-image generation unit shown in FIG. 6.

FIG. 9 is a block diagram illustrating an example of a configuration of the information processing apparatus according to a fourth embodiment.

FIG. 10 is a flowchart illustrating an example of processing performed by a high-quality-enhancement-possibility determination unit according to the fourth embodiment.

### DESCRIPTION OF THE EMBODIMENTS

Hereinafter, embodiments will be explained in detail with reference to the accompanying drawings. It is to be noted that the following embodiments do not limit the recitations according to the claims. Although a plurality of features are described in the embodiments, all of the plurality of features are not necessarily essential to the disclosure, and the plurality of features may be combined arbitrarily.

### First Embodiment

An information processing apparatus according to a first embodiment will be explained. The information processing apparatus according to the present embodiment performs image-quality evaluation by receiving, as an input, an image (evaluation-target image) that is a target of image-quality evaluation, and outputting an evaluation value for the image quality. In the present embodiment, as an example of the image quality to be evaluated, a case in which a degree of focus with respect to a subject is evaluated will be explained. Additionally, in the present embodiment, in a case in which a degree of focus with respect to an eye region of a human face is evaluated will be explained as an example. However, the present embodiment is not limited to these examples, and image quality other than the focus can also be evaluated by the method of the present embodiment, and it is also possible to evaluate any desired region of a target other than the eye.

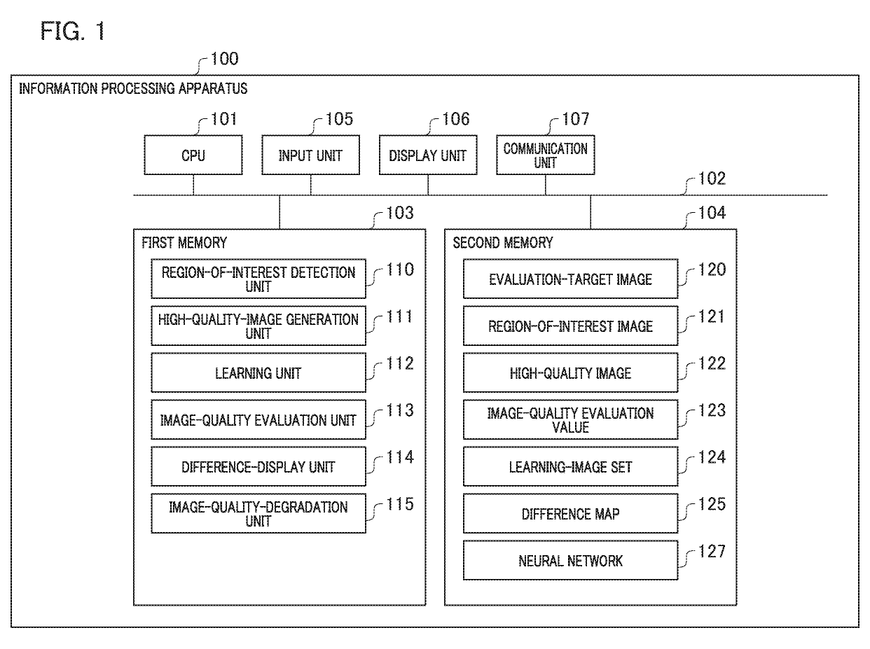

FIG. 1 is a diagram illustrating an example of a configuration of an information processing apparatus 100 according to the present embodiment. As an example of a hardware configuration, the information processing apparatus 100 includes a CPU 101, a calculator bus 102, a first memory 103, a second memory 104, an input unit 105, a display unit 106, and a communication unit 107.

The CPU 101 performs overall control of the information processing apparatus 100. The first memory 103 and the second memory 104 are memories that store a control program for executing processing according to the present embodiment and various types of data. Although, in FIG. 1, the first memory 103 mainly stores control programs and the second memory 104 mainly stores various types of data, this is not particularly limited provided that similar data can be stored anywhere in the entire information processing apparatus 100.

As shown in FIG. 1, a region-of-interest detection unit 110, a high-quality-image generation unit 111, a learning unit 112, an image-quality evaluation unit 113, a difference display unit 114, and an image-quality degradation unit 115 are stored in the first memory 103. These units are configured, for example, as control programs executed on the CPU 101. Therefore, these units function as respective units when executed by the CPU 101. Additionally, all of the above-described units may be configured as a single control program, or a plurality of units may be configured together, such as a control program operating during image-quality evaluation and a control program operating during learning. In the operation of each unit to be described below, the operation will be explained as being executed by the CPU 101.

Similarly, an evaluation-target image 120, a region-of-interest image 121, a high-quality image 122, an image-quality evaluation value 123, a learning-image set 124, a difference map 125, and a neural network 127 are stored in the second memory 104. These data and the like are generated or used by the above-described respective units.

The input unit 105 is configured of a keyboard or a touch panel and the like and receives input from a user. The display unit 106 is configured of a display device such as a liquid crystal display and can display processing results to the user. The communication unit 107 can transmit and receive data by communicating with an external apparatus. The calculator bus 102 connects the respective functional units of the information processing apparatus 100. The information processing apparatus 100 according to the present embodiment can be configured, for example, as a computer including a program for executing the respective processing to be explained below.

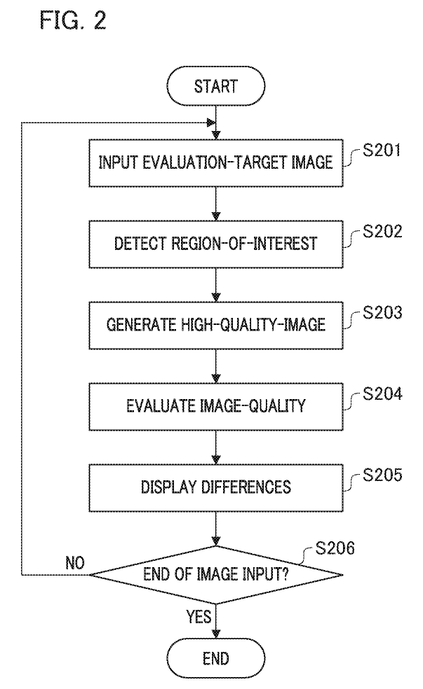

Next, an overall flow of the processing (information processing method) of the present embodiment will be explained with reference to the flowchart of FIG. 2. First, in step S201, one image that is a target of evaluation is received (input) and stored in the second memory 104 as the evaluation-target image 120. The image that is the target of evaluation may be received by the CPU 101 from an external apparatus via the communication unit 107. The external apparatus may be a storage device or an imaging device such as a camera and may alternatively be an external network such as the Internet.

Next, in step S202, the region-of-interest detection unit 110 extracts a region of interest from the evaluation-target image 120 and stores the extracted region of interest in the second memory 104 as the region-of-interest image 121. The region-of-interest detection unit 110 detects, in the image, a region that should be brought into focus as a target of image-quality evaluation. What region is set as the region of interest is arbitrary. The region-of-interest detection unit 110 detects a desired region of interest, for example, by performing prior learning.

In the present embodiment, a case is assumed in which focus evaluation is performed with respect to the eye region of a human face, and the region-of-interest detection unit 110 is assumed to detect the eye region of the human. Methods for detecting a human face or an eye region from within an image are widely known in the art, and therefore, a detailed explanation thereof will be omitted here. In a case in which a plurality of people exists in the image, or in a case in which one of two eyes is to be selected as the region of interest, any rule may be provided. For example, the region of the eye having the largest size may be selected.

Additionally, the region-of-interest detection unit 110 may also store the entire evaluation-target image 120 as the region-of-interest image 121. For example, in a case in which it is desired to perform image-quality evaluation across an entire image, such as an image of a landscape captured with a wide-angle lens, without paying particular attention to a specific part of a specific subject, such a method may be desirable.

Next, in step S203, the high-quality-image generation unit 111 enhances the image quality of the region-of-interest image 121, and stores the enhanced image in the second memory 104 as the high-quality image 122. The high-quality-image generation unit 111 is trained, for example, as a neural network. This neural network has been trained such that a low-quality image is used as an input image and a high-quality image obtained by enhancing the input image is output. For example, when an image in which the focus is slightly off is input, an image having better focus can be output. That is, the high-quality-image generation unit 111 generates the high-quality image 122, which has a higher image quality than that of the evaluation-target image 120, based on the evaluation-target image 120.

The neural network used by the high-quality-image generation unit 111 has been previously trained by the learning unit 112, which will be described below, and is stored in the second memory 104 as the neural network 127. Details of the processing of the learning unit 112 for training the neural network 127 that is used by the high-quality-image generation unit 111 will be described below.

The learning model (neural network 127) that is included in the high-quality image generation unit 111 is trained based on actual image capturing examples. Therefore, under certain image capturing conditions (subject pattern, subject size, illumination environment, and the like), it is possible to generate an image that would be expected to be obtained in a case in which the image was captured with appropriate focus.

Next, in step S204, the image-quality evaluation unit 113 calculates an image-quality evaluation value for the evaluation-target image 120 (region-of-interest image 121) and stores the value in the second memory 104 as the image-quality evaluation value 123.

The image-quality evaluation unit 113 is not particularly limited, provided that it calculates an image-quality evaluation value based on the region-of-interest image 121 and the high-quality image 122, and several examples are given below. First, there is a method that uses a difference in pixel values between the region-of-interest image 121 and the high-quality image 122 as the image-quality evaluation value. Additionally, there is a method in which high-frequency spatial components are respectively calculated for the region-of-interest image 121 and the high-quality image 122, and a difference between the calculated high-frequency components is used as the image-quality evaluation value. Additionally, there is a method in which contrast values (values based on a difference between a maximum value and a minimum value of pixel values) are respectively calculated for the region-of-interest image 121 and the high-quality image 122, and a difference between the calculated contrast values is used as the image-quality evaluation value.

Additionally, a value that is obtained by further applying the values that were obtained in the above examples to a certain function can be used as the evaluation value. Additionally, the function may be trained by supervised learning. For example, it is possible to prepare learning images to which a label indicating superiority or inferiority in quality is assigned as teacher values, and to learn a relation between the image-quality evaluation value and the label indicating good or poor quality. That is, the image-quality evaluation unit 113 performs image-quality evaluation of the evaluation-target image 120 based on a difference between the evaluation-target image 120 and the high-quality image 122. Furthermore, the image-quality evaluation unit 113 performs evaluation of the image quality based on a difference between the region of interest of the evaluation-target image 120 and the high-quality image 122.

Next, in step S205, the difference display unit 114 displays, on the display unit 106, a difference between the region-of-interest image 121 and the high-quality image 122. The details of the difference display unit 114 will be described below.

Next, in step S206, the CPU 101 (control program) determines whether or not all images that are to be evaluation targets have been processed. If an image that is to be an evaluation target remains, the processing returns to step S201, and if no evaluation-target images remain, the processing is terminated.

The overall flow of the processing of the present embodiment has been described above. Note that after calculating an image-quality evaluation value for each of a plurality of images as described above, it is possible to perform the selection of images based on the image-quality evaluation values of the respective images, perform ordering and display, or perform determination of superiority or inferiority quality. That is, a selection unit that performs selection of the evaluation-target image 120 based on a result of evaluation by the image-quality evaluation unit 113 may be provided.

According to the explanation of the above flowchart, step S203 functions as a high-quality-image generation step, and step S204 functions as an image-quality evaluation step.

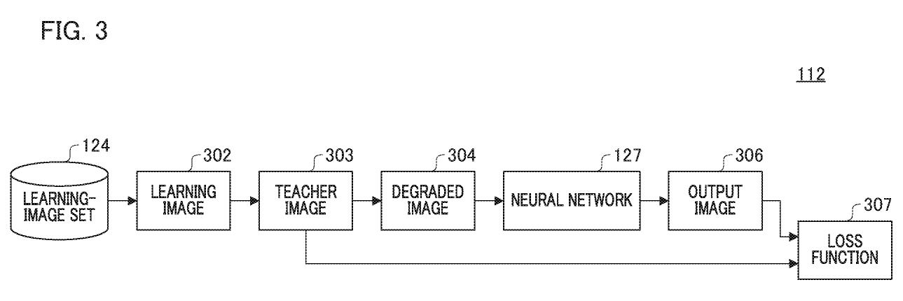

FIG. 3 is a diagram illustrating the learning unit 112 according to the present embodiment. The learning unit 112 trains the neural network 127 such that the neural network 127 uses a low-quality image as an input image and outputs a high-quality image that is obtained by enhancing the input image.

The learning-image set 124 is a set of images in which focus is sufficiently obtained in a region of interest. Although high-frequency components and contrast values vary depending on illumination conditions, the size of a subject, a pattern of the subject, and the like, in the present embodiment, an image in which it is recognized that focus has been sufficiently obtained in the region of interest is defined as a high-quality image. Here, although the learning-image set 124 is assumed to store a plurality of images in the second memory 104 in advance, the learning-image set 124 may be configured such that the images can be acquired from outside through the communication unit 107.

In collecting high-quality images for learning, for example, in commercial photographs used for posters, magazines, and the like, it can be expected that images in which focus on the eyes of a human subject is sufficiently obtained are selected and then used. Therefore, it is possible to easily collect images in which focus is sufficiently obtained. Alternatively, the images may be artificially generated by computer graphics and the like.

A learning image 302 is one image extracted from the learning-image set 124.

A teacher image 303 is an image of the region of interest that has been extracted by the region-of-interest detection unit 110 from the learning image 302. The region-of-interest detection unit 110 is used both for quality evaluations and for learning. As described above, the processing contents of the region-of-interest detection unit 110 have already been explained.

A degradation image 304 is a low-quality image that was obtained by degrading the image quality of the teacher image 303 using the image-quality degradation unit 115. In the present embodiment, the image-quality degradation unit 115 is a unit that applies defocus to an image. For example, a Gaussian filter with an arbitrary sigma may be applied to the image. The neural network 127 is trained while randomly changing the sigma value, which represents the intensity of defocus, within an arbitrary range. For example, a range of sigma, from a sigma with almost no defocus to a sigma of a degree of blur that is the range desired for focus evaluation, is randomly selected for training the neural network 127.

The neural network 127 is an arbitrary neural network, its structure being without limitation, and herein it is explained as one that inputs an image and outputs an image.

An output image 306 is an output image from the neural network 127.

A loss function 307 is a loss function of the learning unit 112. The learning unit 112 performs training such that the difference between the output image 306 and the teacher image 303 is minimized. The learning unit 112 repeatedly updates the parameters of the neural network 127 so as to minimize the loss based on the difference between the output image 306 and the teacher image 303 for a large number of learning images. The learning method for the neural network itself is well known, and a detailed explanation thereof will be omitted here. Learning is repeated until predetermined conditions are satisfied, and is then terminated. For example, learning is repeated until the loss during learning becomes equal to or less than a predetermined value, or a number of repetitions reaches a predetermined number. The neural network 127 is stored in the second memory 104 upon completion of learning.

In this context, examples of loss functions minimized through the learning include the pixel-value difference between the output image 306 and the teacher image 303, or the square of that difference. Additionally, the loss function may also be based on a difference between values of high-frequency components of the output image 306 and the teacher image 303. Additionally, the loss function may also be based on the difference between the contrast values of the output image 306 and the teacher image 303. This difference is not necessarily the same as the difference used by the image-quality evaluation unit 113 when calculating the image-quality evaluation value explained above. For example, the learning unit 112 may perform learning using a loss function based on a pixel-value difference, and the image-quality evaluation unit 113 may calculate an evaluation value based on a difference in high-frequency components.

The high-quality-image generation unit 111 described above generates the high-quality image 122 from the evaluation-target image 120 using the neural network 127 that was trained by the learning unit 112. In this case, the evaluation-target image 120 is input to the neural network 127, and the output image from the neural network 127 may be used as the high-quality image 122.

Through the learning described above, the neural network 127 can be trained such that, when a low-quality defocused image is used as an input image, an enhanced high-quality image having reduced defocus is output (generated). The high-quality image is learned based on actual image capturing examples that are represented by the learning images, and it can be expected that a natural high-quality image that is actually realizable under the image capturing conditions of the input image will be generated.

That is, the learning unit 112 utilizes a high-quality image as the teacher image 303 and inputs the low-quality image (the degradation image 304), which is obtained by degrading the teacher image 303, into the neural network 127. Then, the neural network 127 is trained such that the difference between the output image 306 output by the neural network 127 and the teacher image 303 is minimized.

As a method of enhancing image quality by reducing defocus in an image, a method that does not rely on learning in the same manner as the present embodiment may also be adopted. For example, image sharpness may be increased through image processing such as high-frequency component emphasis or edge enhancement. However, compared with such methods, the method of the present embodiment is expected to generate an image that exhibits spatial frequency and contrast at a level that is actually realizable according to the input image.

The image-quality evaluation unit 113 of the present embodiment calculates an evaluation value based on the difference between the evaluation-target image 120 and the corresponding high-quality image 122 that has been generated therefrom. Therefore, it is important that the high-quality image 122 is generated with a degree of quality that is naturally realizable under the image capturing conditions of the evaluation-target image 120. Comparison with an image that exhibits unnaturally emphasized edges beyond what is realizable under the image capturing conditions of the evaluation-target image 120 leads to an inaccurate evaluation value. In the present embodiment, the high-quality image 122 is generated using the neural network 127 that restores an actual high-quality image. Accordingly, a feature of the present embodiment is that a natural high-quality image 122 is obtained for the input image (the evaluation-target image 120), which represents a quality that is actually realizable when captured with the correct focus.

Additionally, if the input image already has sufficiently correct focus, it is expected that learning is performed such that an image nearly identical to the input image will be output. As described above, the present embodiment provides an effect different from methods that simply improve image quality through edge enhancement, and the like.

Additionally, methods such as high-frequency component emphasis and edge enhancement cannot restore fine textures (patterns) that have been lost due to image blurring during image capturing. For example, fine textures of skin and hair cannot be restored by methods such as edge enhancement. Since the high-quality-image generation unit 111 of the present embodiment performs learning-based image generation, even textures that have been lost in the evaluation-target image 120 are expected to be reproduced and generated according to the input image (the evaluation-target image 120).

Although a texture that is reproduced through learning is not exactly the same as the texture of the actual subject, it can be expected that a texture similar to the texture that would have been obtained by image capturing with the correct focus will be generated. If the image-quality evaluation unit 113 calculates an evaluation value based on differences in high-frequency components between the region-of-interest image 121 and the high-quality image 122, without directly relying on pixel-value differences, there is no problem even if the texture generated is not exactly the same as the texture of the actual subject.

Note that, although, in the present embodiment, focus (a degree of defocus) is taken as an example of the image quality that is evaluated by the image-quality evaluation unit 113, the present disclosure is not limited thereto. Although the degradation image 304 in FIG. 3 has been explained as an image obtained by applying arbitrary defocus to the teacher image 303 using a Gaussian filter and the like, replacing this degradation processing with another image-quality degradation factor enables the evaluation of different quality factors.

For example, if learning is performed such that the degradation image 304 is an image in which arbitrary blur (anisotropic defocus) is given to the teacher image 303, image quality can be evaluated in terms of the amount of blur due to subject motion (motion blur), camera shake, and the like. In this case, the high-quality image used as the teacher image is regarded as an image having sufficiently low blur.

Additionally, for example, if learning is performed such that the degradation image 304 is obtained by applying arbitrary noise to the teacher image 303, image quality can be evaluated based on the amount of noise. Similarly, if the degradation image 304 is generated by applying color discrepancy, the image quality related to color discrepancy can be evaluated. Additionally, a degradation factor applied by the image-quality degradation unit 115 may be a combination of multiple factors, not just a single one. For example, the image-quality degradation unit 115 may generate the degradation image 304 by applying defocus, blur, and noise, each having a random intensity, to the region-of-interest image 121. In these cases, as well as in the case of blur, an image recognized as having sufficiently little noise or color discrepancy becomes a high-quality image serving as the teacher image.

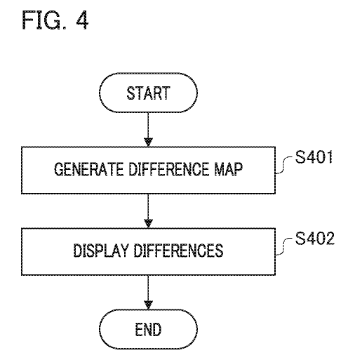

FIG. 4 is a flowchart for explaining the difference display unit 114. First, in step S401, the difference display unit 114 generates a difference map that indicates a difference between the region-of-interest image 121 and the high-quality image 122, and stores the difference map in the second memory 104 as the difference map 125.

Here, as an example, the difference map 125 is set as a four-channel color image with transparency, consisting of Red, Green, Blue, Alpha (RGBA). For example, the absolute value of the pixel-value difference between the region-of-interest image 121 and the high-quality image 122 is set to the A channel (a transparency channel, α channel) of the difference map 125. The A channel is transparent when the value is 0. Then, values of the R (red) channel are all set to 100%, and values of the G (green) and B (blue) channels are set to 0.

It should be noted that the present disclosure is not limited to setting the pixel-value difference between the region-of-interest image 121 and the high-quality image 122 as the A-channel value, and alternative methods may be employed. For example, high-frequency-component extraction images may be generated respectively for the region-of-interest image 121 and the high-quality image 122, and the difference between these high-frequency-component extraction images may be set. Thus, during the superimposed display in the next step S402, regions with large differences are displayed in red.

Next, in step S402, the difference display unit 114 superimposes the difference map 125 on the region-of-interest image 121 and outputs the display to the display unit 106. According to the present embodiment, regions where the difference between the region-of-interest image 121 and the high-quality image 122 is large are displayed in red, with the density corresponding to the magnitude of the difference. That is, the difference display unit 114 displays the image-quality evaluation result that is output by the image-quality evaluation unit 113 as being superimposed on the evaluation-target image 120.

Note that the superimposed display and the display of only the region-of-interest image 121 may be switched as appropriate according to a user instruction received via the input unit 105. Additionally, the difference map 125 may also be superimposed and displayed on the evaluation-target image 120. In this case, the superposition is performed in accordance with the position of the region of interest that has been detected by the region-of-interest detection unit 110.

Performing this display enables a user to grasp which portion of the evaluation-target image influences the image-quality evaluation.

In the present embodiment, an ideal image (high-quality image 122) is inferred, this image representing the optimal quality image that is achievable for the evaluation-target image (evaluation-target image 120) considering its image capturing conditions such as the subject and illumination conditions. The feature of the present embodiment lies in performing the image-quality evaluation based on a comparison between the ideal image and the actual image (the evaluation-target image 120). The present embodiment achieves the above by having a high-quality-image generation unit 111 that trains a neural network 127 to generate a high-quality image from an input image based on an actual high-quality image, as a method of generating an ideal image according to the input image.

According to the present disclosure, an image-quality evaluation can be performed according to the image capturing conditions.

### Second Embodiment

Next, an information processing apparatus according to the second embodiment will be explained. Note that explanations of configurations that are identical to those of the first embodiment will be omitted, and mainly the portions that are different from those of the first embodiment will be explained below.

In the first embodiment, the neural network 127 receives only an image in which the region of interest has been extracted (the region-of-interest image 121) as its input. In the present embodiment, additional information is input to the neural network 127 together with the extracted region-of-interest image. Note that the output of the neural network 127 is the high-quality image 122, which is based on the region-of-interest image 121, as in the first embodiment.

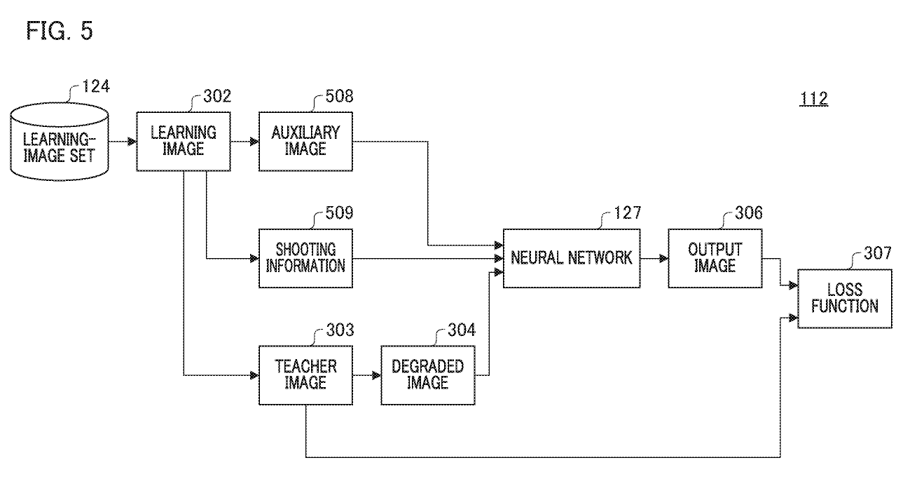

FIG. 5 is an explanatory diagram of the learning unit 112 in the present embodiment. In FIG. 5, the amount of input to the neural network 127 is greater than that in the neural network 127 that is shown in FIG. 3. In FIG. 5, in addition to the degradation image 304 of the teacher image 303 that is obtained by extracting the region of interest, an auxiliary image 508 that is obtained by extracting all or a predetermined portion of the learning image 302 is also input into the neural network 127.

The auxiliary image 508 is an image that is generated based on the learning image 302 and may be the entire learning image 302 before the region of interest is extracted, or may be an image that is obtained by extracting a region other than the region of interest from the learning image 302. Alternatively, the supplemental image 508 may be a resized version of the learning image 302 and the like. That is, in addition to the image of the region of interest, an image that is not identical to the region-of-interest image that is based on the teacher image 303 may also be input to the neural network 127.

Image capturing information 509 is information relating to image capturing from the time of the image capturing of the learning image 302, and includes shutter speed, exposure, autofocus (AF) information, scene-recognition information, lens information, and the like. If such image capturing information is appended to an image as Exif information and the like, that information may be used. That is, in addition to the image of the region of interest, image capturing information for the teacher image 303 may be input to the neural network 127.

These additional inputs to the neural network 127 in the present embodiment may be supplied to a specific intermediate layer of the neural network 127, and one or more intermediate layers may also be added to incorporate this information.

By adopting such a configuration, the high-quality image 122 can be generated based on the image information for the region of interest, as well as information for the entire captured scene and the image capturing information. That is, the training enables image generation by inferring the degree of image quality that is expected to be realizable for the evaluation-target image 120, based on the overall image and the image capturing information. Note that the auxiliary image 508 and the image capturing information 509 may be configured so that only one of them is input.

### Third Embodiment

Next, an information processing apparatus according to the third embodiment will be explained. Note that explanations of configurations that are identical to those of the first and second embodiments will be omitted, and mainly portions that are different from those of the first and second embodiments will be explained below.

In the present embodiment, modified examples of how to generate the teacher images and degraded images during learning will be explained. In the first embodiment, an example in which evaluation of the focus on a human eye is performed has been explained. In the case of photographing a human eye, there are cases in which an object that partially conceals the eye in the foreground, such as bangs covering the eye, appears in the image. There are also cases in which the eye is seen through an occluding object, such as a net or eyeglasses, with the occluding object being located in front of the eye. Since the autofocus of a camera is based on image contrast and the like, if the contrast of an occluding object such as bangs is high, the focus may be adjusted to the occluding object, resulting in the eye behind it being slightly out of focus.

The present embodiment is intended to prevent the image-quality evaluation value from becoming inaccurate even in such cases. Specifically, when the learning unit 112 trains the neural network that is used by the high-quality-image generation unit 111, images in which the object to be focused on is occluded are also included in the learning.

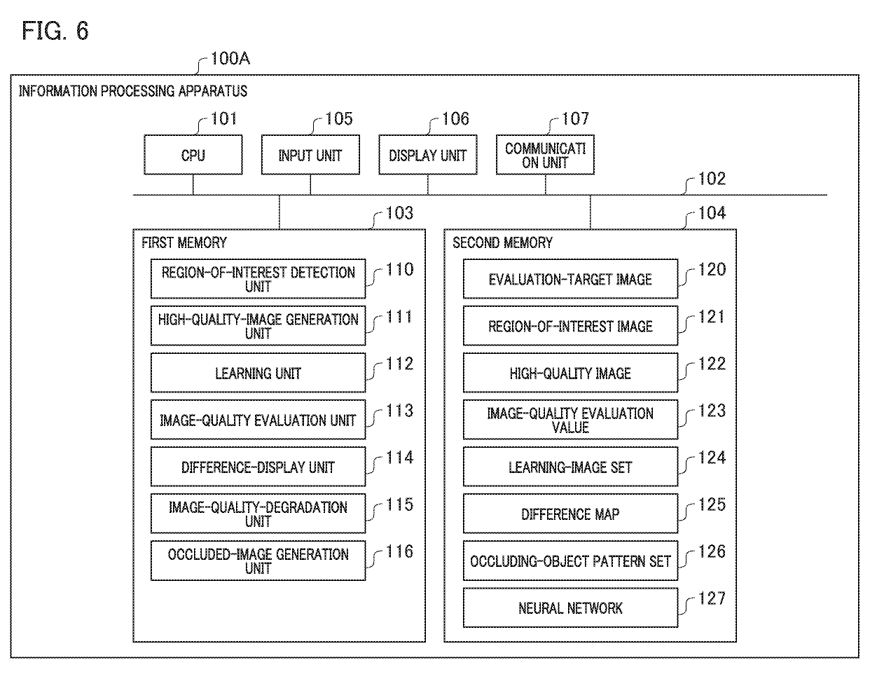

FIG. 6 illustrates an example of the configuration of the information processing apparatus 100A according to the present embodiment. The present embodiment differs from FIG. 1 in that an occluded-image generation unit 116 is stored in the first memory 103, and an occluding-object pattern set 126 is stored in the second memory 104.

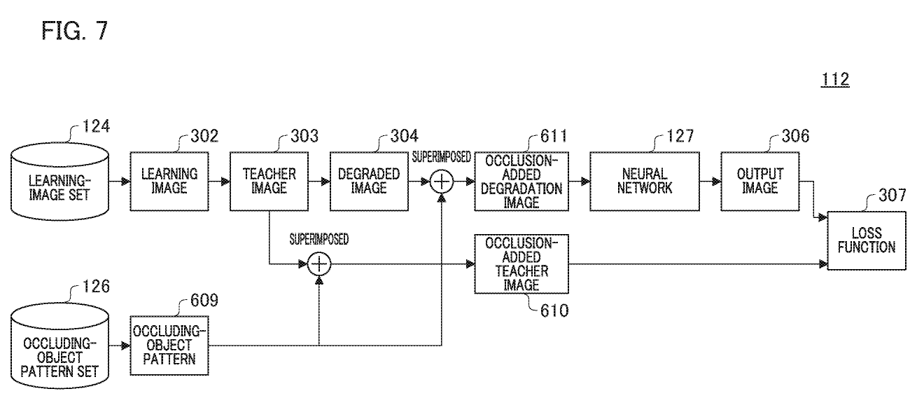

FIG. 7 is an explanatory diagram of the learning unit 112 in the present embodiment. The occluding-object pattern set 126 is a dataset in which patterns of occluding objects, such as those described above, are collected in advance using images in which focus has been sufficiently achieved. If objects such as bangs, a net, and eyeglasses become occluding objects for the eye that is the subject of attention, as described above, images of bangs, a net, and eyeglasses are prepared. As will be described below, since the occluding-object pattern set 126 is used by being superimposed on a teacher image, portions of the image other than the occluding object are set to be transparent so that the pattern can be superimposed on other images.

The occluding-object pattern set 126 is stored in advance in the second memory 104. Alternatively, it may be obtained from an external source via the communication unit 107, or an occluding-object pattern may be generated artificially based on predetermined rules.

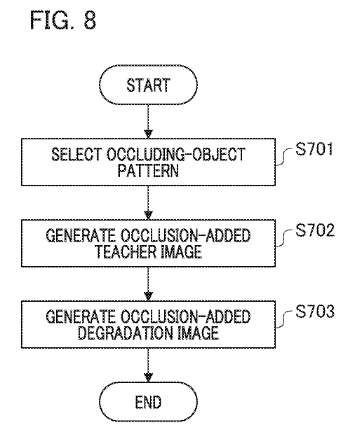

The occluded-image generation unit 116 selects one occluding-object pattern from the occluding-object pattern set 126 that has been prepared in advance and superimposes this on the teacher image 303 in order to generate an occlusion-added teacher image 610. That is, the occluded-image generation unit 116 generates an occluded image in which the teacher image 303 is partially occluded. FIG. 8 illustrates a flowchart of the occluded-image generation unit 116.

In step S701, the occluded-image generation unit 116 selects one occluding-object pattern from the occluding-object pattern set 126 in the second memory 104. The selected pattern corresponds to an occluding-object pattern 609 in FIG. 7. The occluding-object pattern 609 is data that is randomly selected from the occluding-object pattern set 126 each time that the learning process is repeated. Additionally, the occluding-object pattern 609 may be selected according to the image content of the teacher image 303. For example, if the occluding-object pattern 609 is an eyeglasses image, an eyeglasses image that is oriented appropriately for the face orientation in the teacher image 303 may be selected as the occluding-object pattern 609.

In step S702, the occluded-image generation unit 116 superimposes the occluding-object pattern 609 that was selected in step S701 onto the teacher image 303 in order to generate the occlusion-added teacher image 610. For example, if the teacher image 303 is an image of a human eye and the occluding-object pattern 609 is an image of bangs, the occlusion-added teacher image 610 is generated as an image in which the bangs appear to cover the eye.

In step S703, the same occluding-object pattern 609 that was selected in step S701 is superimposed on the degradation image 304 in order to generate an occlusion-added degradation image 611. Accordingly, the same occluding-object pattern 609 is superimposed on both the degradation image 304 and the teacher image 303.

The process returns to FIG. 7, and the occlusion-added degradation image 611 is input to the neural network 127.

The loss function 307 calculates a loss value based on the output image 306 and the occlusion-added teacher image 610. The learning unit 112 in the present embodiment performs learning based on this loss function. The details are the same as in the first embodiment. That is, the learning unit 112 trains the neural network 127 using occluded images.

By adopting such a configuration, learning is performed using images in which the occluding object is in focus, while the subject of interest is blurred through degradation processing. That is, even in a case in which an image in which the eye is out of focus and an occluding object in front of the eye is in focus is input, the neural network 127 is trained to output an image in which the eye region has a minimized difference from the occlusion-added teacher image 610. Additionally, in regions where the occluding-object pattern 609 is present, the occlusion-added degradation image 611 and the occlusion-added teacher image 610 that are input to the neural network 127 are identical, and the training is performed such that no changes occur in those regions in the output.

During image-quality evaluation, if the evaluation-target image 120 is an image in which the eye is out of focus while the bangs covering the eye are in focus, the region corresponding to the bangs remains largely unchanged, and a high-quality image 122 is generated in which the eye appears to be in focus. Since the image-quality evaluation unit 113 calculates an image-quality evaluation value based on the difference between the region-of-interest image 121 and the high-quality image 122, the evaluation is not affected by the occluding object. Although conventional methods using spatial-frequency components or contrast are affected by occluding objects and therefore cannot provide accurate evaluation, in the present embodiment, the influence of such occluding objects is reduced, thereby enabling more accurate image-quality evaluation.

Next, an information processing apparatus according to a fourth embodiment will be explained. Note that explanations of configurations that are identical to those of the first to third embodiments will be omitted, and mainly portions that are different from those of the first to third embodiments will be explained below.

A feature of the present embodiment is to determine whether or not the high-quality-image generation unit 111 can perform high-quality enhancement on the evaluation-target image 120.

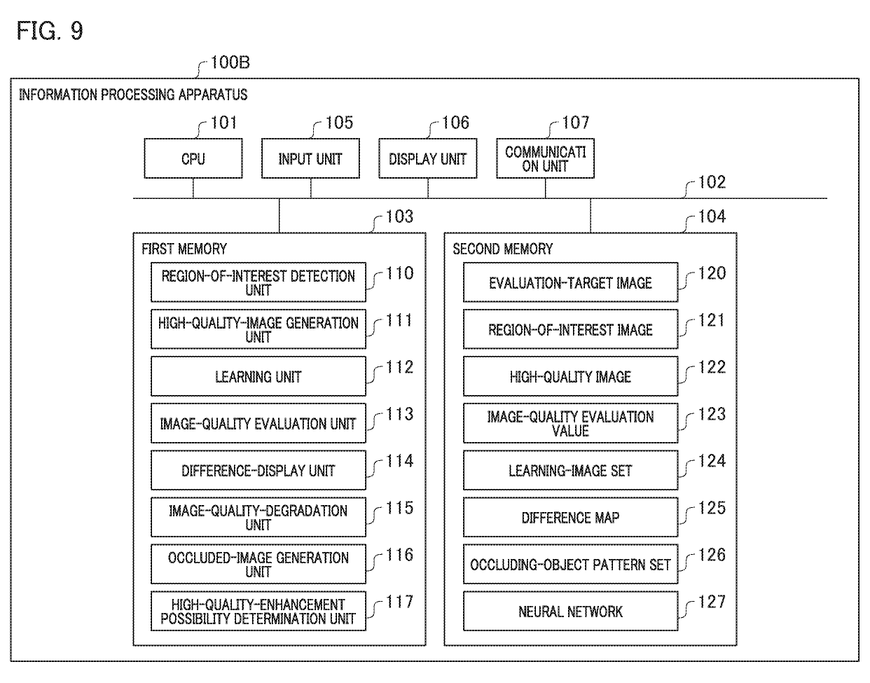

FIG. 9 illustrates an example of the configuration of an information processing apparatus 100B according to the present embodiment. The present embodiment differs from FIG. 6 in that a high-quality-enhancement possibility determination unit 117 is stored in the first memory 103.

As described above, the high-quality image 122 needs to be generated based on the region-of-interest image 121. The high-quality image 122 needs to be an image that can be regarded as substantially the same as the region-of-interest image 121 in all aspects other than image quality.

Since the high-quality-image generation unit 111 has been trained by the learning unit 112, in a case in which an image that has not been learned is input, the high-quality-image generation unit 111 may output an image that greatly differs from the region-of-interest image 121. For example, in a case in which the image is blurred to an extent that the image content cannot be recognized when the image-quality degradation unit 115 generates the degradation image 304 during learning, it is impossible to output, from the degradation image 304, an image similar to the teacher image 303.

Thus, there is an inherent limitation on the images that the high-quality-image generation unit 111 can enhance, and there is the concern that an image in which characteristics of the subject are no longer present cannot be accurately enhanced. Additionally, there is the concern that neural networks that are used for image generation tend to output unstable images in a case in which an input that has not been learned is provided. The present embodiment is a measure for handling such a case.

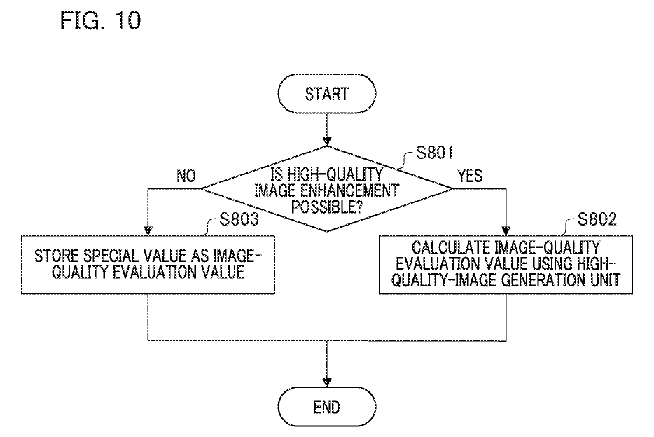

FIG. 10 is a flowchart illustrating a calculation method for the image-quality evaluation value in the present embodiment. Before the processing shown in FIG. 10, it is assumed that the processes up to step S202 in FIG. 2 have been completed. That is, the region-of-interest image 121 has been stored in the second memory 104.

First, in step S801, the high-quality-enhancement possibility determination unit 117 determines whether or not the region-of-interest image 121 has an image quality that allows high-quality enhancement by the high-quality-image generation unit 111. That is, the high-quality-enhancement possibility determination unit 117 functions as a determination unit that determines whether or not the image quality of the evaluation-target image 120 is sufficient for high-quality enhancement by the high-quality-image generation unit 111.

As processing performed by the high-quality-enhancement possibility determination unit 117, for example, the determination may be performed based on whether spatial-frequency components or contrast of the region-of-interest image 121 are equal to or greater than predetermined thresholds. Thus, it is possible to determine the degree to which the subject is clearly photographed in the region-of-interest image 121.

When the learning unit 112 generates degraded images using the image-quality degradation unit 115, the above-described thresholds may be determined according to the degree to which the image-quality degradation unit 115 has degraded the images. Since learning is not performed to enhance an image that is more degraded than the degraded images that were generated by the image-quality degradation unit 115, the quality of the degraded images generated by the image-quality degradation unit 115 defines the upper limit of images for which high-quality enhancement is possible. For example, in a case in which a Gaussian filter is applied to the teacher image to generate a defocused image as a degraded image, the extent of the spatial-frequency components in a case in which the image is degraded using an upper-limit sigma value of the Gaussian filter may be examined in advance and set as the above-described thresholds.

If it is determined that high-quality enhancement is possible, the process proceeds to step S802, and if it is determined that high-quality enhancement is not possible, the process proceeds to step S803.

In step S802, since high-quality enhancement is possible, processes similar to step S203 and the subsequent steps in FIG. 2 are performed. As was explained in the first embodiment, the image-quality evaluation unit 113 calculates the image-quality evaluation value 123 through the processing described in the first embodiment.

In step S803, since the high-quality-image generation unit 111 cannot be used, the image-quality evaluation unit 113 stores a special value as the image-quality evaluation value 123. Additionally, the user may be notified via the display unit 106 that the image has been determined to be an image for which high-quality enhancement is not possible. That is, the image-quality evaluation unit 113 performs image-quality evaluation based on the result of the high-quality-enhancement possibility determination unit 117.

The special value described above is a specific value indicating that image quality evaluation is not possible due to processing using the high-quality image generation unit 111. In an application that performs the selection of images using the image-quality evaluation value 123, in a case in which the image-quality evaluation value 123 is the special value described above, it may be determined that the image quality is low. Alternatively, the user may be prompted to determine an image selection, treating the image as one for which automatic determination of image quality is difficult.

By adopting a configuration such as that of the present embodiment, it becomes possible to avoid outputting an inaccurate image-quality evaluation value for an image for which generation of a high-quality image by the high-quality-image generation unit 111 is difficult.

### Other embodiments

The present disclosure can also be realized by a process in which a program that realizes one or more functions of the above-described embodiments is supplied to a system or an apparatus via a network or a storage medium, and one or more processors in a computer of the system or the apparatus read out and execute the program. Additionally, it is also possible to realize the present disclosure by a circuit (for example, an ASIC) that realizes one or more of the functions.

Although embodiments of the present disclosure have been described above, the present disclosure is not limited to these embodiments, and various modifications and alterations can be made within the scope of the spirit of the disclosure.

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-045334, filed Mar. 19, 2025, which is hereby incorporated by reference herein in its entirety.

What is claimed is:

1. An information processing apparatus comprising:
at least one memory storing instructions; and
at least one processor executing the stored instructions causing the information processing apparatus to:
generate a high-quality image, based on an evaluation-target image using a neural network, the high-quality image having an image quality that is higher than an image quality of the evaluation-target image; and
perform an evaluation of the image quality of the evaluation-target image based on a difference between the evaluation-target image and the high-quality image.

2. The information processing apparatus according to claim 1,
wherein executing the stored instructions by the processor further causes the information processing apparatus to:
perform training of the neural network, and
wherein, in the training, the neural network is trained such that a high-quality image is used as a teacher image, a low-quality image that is obtained by causing image-quality degradation to the teacher image is input to the neural network, and a difference between an output image that is output from the neural network and the teacher image is minimized.

3. The information processing apparatus according to claim 2,
wherein executing the stored instructions by the processor further causes the information processing apparatus to:
detect a region of interest from the teacher image, and
wherein, in the training, the neural network is trained such that a low-quality image that is obtained by causing image-quality degradation to the region of interest that has been detected is input to the neural network, and a difference between an output image output from the neural network and the region of interest that is detected is minimized.

4. The information processing apparatus according to claim 3, wherein executing the stored instructions by the processor further causes the information processing apparatus to:
input, to the neural network, an image that is not identical to the image of the region of interest obtained based on the teacher image, in addition to the image of the region of interest.

5. The information processing apparatus according to claim 3, wherein executing the stored instructions by the processor further causes the information processing apparatus to:
input, to the neural network, image capturing information for the teacher image, in addition to the image of the region of interest.

6. The information processing apparatus according to claim 2, wherein executing the stored instructions by the processor further causes the information processing apparatus to:
generate an occluded image that partially occludes the teacher image; and
perform the training of the neural network using the occluded image.

7. The information processing apparatus according to claim 1, wherein executing the stored instructions by the processor further causes the information processing apparatus to:
detect a region of interest from the evaluation-target image; and
perform the evaluation of the image quality based on a difference between region of interest of the high-quality image and the region of interest of the evaluation-target image.

8. The information processing apparatus according to claim 1, wherein executing the stored instructions by the processor further causes the information processing apparatus to:
superimpose and display a result of the evaluation of the image quality on the evaluation-target image.

9. The information processing apparatus according to claim 1, wherein executing the stored instructions by the processor further causes the information processing apparatus to:
perform determination of whether the image quality of the evaluation-target image is an image quality that can be enhanced, based on a predetermined threshold; and
perform the evaluation of the image quality based on a result of the determination.

10. The information processing apparatus according to claim 1, wherein executing the stored instructions by the processor further causes the information processing apparatus to:
generate, as the high-quality image, an image, based on the evaluation-target image, the image having blur that is less than blur of the evaluation-target image; and
perform an evaluation of a degree of blur of the evaluation-target image as the image quality.

11. The information processing apparatus according to claim 1, wherein executing the stored instructions by the processor further causes the information processing apparatus to:
perform selection of the evaluation-target image based on a result of the evaluation of the image quality of the evaluation-target image.

12. An information processing method executed by an information processing apparatus, the method comprising:
generating a high-quality image, based on an evaluation-target image using a neural network, the high-quality image having an image quality that is higher than an image quality of the evaluation-target image; and
performing an evaluation of the image quality of the evaluation-target image based on a difference between the evaluation-target image and the high-quality image.

13. A non-transitory storage medium storing a program for an information processing apparatus, causing a computer to perform each step of the information processing method executed by the information processing apparatus, the method comprising:
generating a high-quality image, based on an evaluation-target image using a neural network, the high-quality image having an image quality that is higher than an image quality of the evaluation-target image; and
performing an evaluation of the image quality of the evaluation-target image based on a difference between the evaluation-target image and the high-quality image.
